(19) United States
(12) Patent Application Publication
(10) Pub. No.: US 2026/0059344 A1
(43) Pub. Date: Feb. 26, 2026

(54) RADIO FREQUENCY DEVICES

(71) Applicant: Nordic Semiconductor ASA, Trondheim (NO)

(72) Inventors: Tuomo KUMENTO, Oulu (FI); Tuukka MIETTINEN, Oulu (FI); Aki RANTALA, Oulu (FI)

(73) Assignee: Nordic Semiconductor ASA, Trondheim (NO)

(21) Appl. No.: 19/104,808

(22) PCT Filed: Aug. 31, 2023
(86) PCT No.: PCT/EP2023/073924

§ 371 Date: Feb. 19, 2025

(30) Foreign Application Priority Data
Aug. 31, 2022 (GB) 2212624.7

(51) Int. Cl. H04W 16/26; H04W 48/04; H04W 48/20; H04W 88/06

(52) U.S. Cl. CPC H04W 16/26; H04W 48/04; H04W 48/20; H04W 88/06

(57) ABSTRACT

A radio frequency device arranged to communicate with a radio network cell of a radio network is provided. The radio frequency device is arranged to operate in a first mode in which the radio frequency device communicates with a radio network cell using a standard communication protocol; to operate in a second mode in which the radio frequency device communicates with a radio network cell using a coverage enhancement communication protocol; to operate in a third mode in which the radio frequency device is restricted from communicating with a radio network cell using the coverage enhancement communication protocol; and to transition from operating in the third mode to operating in the second mode without operating in the first mode.

### BACKGROUND OF THE INVENTION

The present invention relates to radio frequency (RF) devices for communicating with radio network cells of radio networks such as Long Term Evolution (LTE) networks.

Many modern telecommunication systems, such as 3GPP LTE networks, include one or more RF devices (referred to as user equipment (UE) in the LTE standard) communicating with one or more base stations (referred to as eNodeBs in the LTE standard).

Each base station provides network coverage over a certain geographical area. This coverage extends to the point at which data can no longer be reliably extracted from signals sent between the RF device and the base station. In LTE, the coverage of a base station may be defined by a threshold Maximum Coupling Loss (MCL), i.e. the maximum tolerable value of coupling loss between a UE and an eNB.

To improve cell coverage, coverage enhancement (CE) communication protocols have been proposed, in which sections of each communication frame are repeated (possibly many times) to enable additional error correction and improved data recovery. For instance, the LTE standard includes CE modes A and B for use when the coupling loss is too high for standard LTE communication. However, CE communication may feature lower data rates and/or increased latencies and/or require additional network resources.

Different networks may implement CE in different ways. Some networks or parts of networks may allow CE communication without restriction. However, CE can be resource intensive, so other networks or parts of networks may place restrictions on when, where and/or by whom CE can be used. For instance, some networks may restrict the use of CE in busy cells, or for particular devices who are not registered for CE use.

If a CE restriction is in place for a given cell, this may be communicated to the relevant device when it first attempts to register to the network (e.g. as part of the LTE attach procedure) and/or when the device enters a new part of the network (e.g. as part of the LTE TAU procedure). The device is thereafter restricted from using CE in the network (e.g. by entering an idle state such as an RRC idle state), although normal operation is still allowed.

However, the applicant has recognised that problems can arise when there are different and/or changing CE restrictions within a network. For instance, a device subject to a CE restriction may not be able to select any cell until it enters a standard coverage zone where the CE restriction does not apply, even if some other cells allow CE operation or CE restrictions change. Some devices, e.g. Internet of Things (IoT) devices that remain largely stationary or devices that move between CE zones of different cells, may thus be unable to make full use of possible CE operation.

An improved approach to coverage enhancement restrictions may be desired.

### SUMMARY OF THE INVENTION

According to a first aspect of the present invention there is provided a radio frequency device arranged to communicate with a radio network cell of a radio network, wherein the radio frequency device is arranged:
to operate in a first mode in which the radio frequency device communicates with a radio network cell using a standard communication protocol;
to operate in a second mode in which the radio frequency device communicates with a radio network cell using a coverage enhancement communication protocol;
to operate in a third mode in which the radio frequency device is restricted from communicating with a radio network cell using the coverage enhancement communication protocol; and
to transition from operating in the third mode to operating in the second mode without operating in the first mode.

Thus, it will be recognised by those skilled in the art that allowing a radio frequency (RF) device to transition directly from a mode in which coverage enhancement (CE) is restricted to one in which CE is permitted, without needing to enter a standard communication mode (e.g. without needing to enter a standard coverage zone of a radio network cell), may improve device operation, because the device is better able to react to changes in CE restrictions. For instance, the device may be able to react more quickly to changes in CE restrictions arising due to physical movement of the device between different cells but also to network, cell or device level changes in CE restrictions. For instance, a network may support only a network-wide CE restriction, but this network-wide restriction may change (e.g. be removed) whilst the device is operated.

The invention extends to a radio network comprising at least one radio network cell and the radio frequency device as disclosed herein.

Conventionally, it would appear counterintuitive to allow a radio frequency device to transition directly from a mode in which coverage enhancement (CE) communication is restricted to one in which CE communication is used, because this would seem to negate the purpose of the restriction (i.e. to prevent the device from using network resources it is not permitted to use). However, the applicant has recognised that allowing the RF device to transition directly to the second mode may be beneficial in some scenarios with changing CE restrictions.

For instance, if the device moves from a CE zone of one cell in which CE is restricted, to a CE zone in another cell which has no restriction, existing CE protocols may prevent the device from communicating with the new cell. Typically, a device stores a CE restriction setting to non-volatile memory (e.g. a dedicated flash memory), and is not able to change this setting until standard communication (which is not restricted) is possible.

The radio frequency device may be arranged to operate in the first mode (i.e. to communicate with a radio network cell using the standard communication protocol) when in a standard coverage zone of a radio network cell. In other words, the radio frequency device may be arranged to operate in the first mode when it receives signals (e.g. from a radio network cell) indicating that the standard communication protocol is in use (e.g. specific paging signals and/or signals with a specific frame structure). The radio frequency device may be arranged to operate in the first mode only when in a standard coverage zone of a radio network cell. The radio frequency device may not operate in the second and third modes when in a standard coverage zone of a radio network cell accessible to the radio frequency device. In other words, the device may not operate in the second and third modes if first mode operation is possible. The radio frequency device may be arranged to operate in the first mode following an initial registration process performed in a standard coverage zone (e.g. an LTE attach procedure) or after moving into a standard coverage zone from an CE zone.

The first mode may represent the normal communication mode for the radio network. The radio network may be designed primarily to support communications with devices using the standard communication protocol.

The radio frequency device may be arranged to operate in the second mode (i.e. to communicate with a radio network cell using the CE communication protocol) when in a CE zone of a radio network cell. The radio frequency device may be arranged to operate in the second mode only when in a CE zone of a radio network cell (e.g. and when not in the standard coverage zone of another radio network cell accessible to the radio frequency device). A CE zone may be larger than a standard coverage zone (e.g. extending further from a base station defining the cell than the standard coverage zone in at least one direction). The radio frequency device may be arranged to operate in the second mode following an initial registration process performed in a CE zone (e.g. an LTE attach procedure) or after moving into a CE zone from a standard coverage zone. The second mode may be described as a CE-active mode.

The radio frequency device may be arranged to operate in the third mode when in a CE zone of a radio network cell and a CE restriction is in place (e.g. when a CE restriction is in place, the radio frequency device is in a CE zone of a radio network cell and is not in the standard coverage zone of another radio network cell accessible to the radio frequency device). The CE restriction may be specific to the network, the cell, a base station or to the device itself. The radio frequency device may be arranged to operate in the third mode in response to an indication from a radio network cell that CE is restricted. The third mode may be described as a CE-restricted mode. The device may be effectively prevented from to communicating with the radio network when in the third mode. The radio frequency device may be able to transition from the third mode into the first mode, for instance if the device moves to a position within a standard coverage zone of an appropriate radio network cell.

An indication that CE is restricted may be received whilst the radio frequency device is in a standard coverage zone (i.e. where the CE restriction does not apply), in which case the device may be arranged to enter the third mode when subsequently entering a CE zone. Alternatively, an indication that CE is restricted may be received whilst the radio frequency device is already in a CE zone. The radio frequency device may be arranged to operate in the third mode following a registration procedure with a radio network cell, said registration procedure including an indication from the radio network cell that CE operation is restricted.

The radio frequency device may comprise a memory (e.g. a non-volatile memory). The radio frequency device may be arranged to store information indicating a CE restriction (e.g. setting a CE restriction flag) to said memory when receiving an indication that CE is restricted. For instance, the RF device may comprise a non-volatile memory such as a flash memory arranged to store CE restriction information. The memory may be separate to a memory used for storing device firmware or software. The memory may be a dedicated memory used only for storing CE restriction information. The RF device may be arranged to operate in the third mode based on restriction information stored in a memory. For instance, the RF device may be arranged to operate in the third mode if it is in a CE zone of a radio network cell and the memory indicates that CE operation is restricted.

The CE restriction may be implemented using existing cell-selection processes. For instance, when operating in the third mode the radio frequency device may be prevented from selecting cells that can only be accessed using CE operation (e.g. cells which do not satisfy selection criteria necessary for the standard communication protocol). In other words, when operating in the third mode the radio frequency device may be prevented from selecting cells that would require CE operation to communicate with (e.g. cells the radio frequency device is in a CE zone of).

In some embodiments, the radio frequency device may be prevented from establishing an RRC connection to a radio network cell when operating in the third mode. The radio frequency device may remain camped on a radio network cell whilst operating in the third mode.

The standard communication protocol may comprise communicating with a radio network cell (e.g. sending and/or receiving data packets) using a first frame structure. The standard communication protocol may comprise an LTE-M communication protocol (e.g. the first frame structure may comprise an LTE-M uplink or downlink frame structure). The first frame structure may be associated with a first data rate and/or a first latency.

The CE communication protocol may comprise communicating with a radio network cell (e.g. sending and/or receiving data packets) using a second frame structure. The second frame structure may comprise the first frame structure with one or more repeated portions, e.g. with one or more sub-frames repeated one or more times. The second frame structure may be associated with a second, lower data rate and/or a second, higher latency. The CE communication protocol may comprise LTE-M coverage enhancement protocol such as that used in LTE-M CE Mode A or Mode B.

In a set of embodiments, the radio frequency device is arranged, when operating in the third mode, to perform a restriction check on CE restrictions. The radio frequency device may be arranged to transition from operating in the third mode to operating in the second mode if said restriction check indicates that CE operation is not restricted (e.g. because the device has moved to a different cell or because the cell or device restrictions have changed). The radio frequency device may be arranged to perform a restriction check in response to a variety of triggers, e.g. a time-based trigger, a position-based trigger, a combination of the two or something else. In a set of embodiments, the radio frequency device is arranged to receive information (e.g. from a radio network cell) indicating when and/or how to perform a restriction check (e.g. at the same time as receiving an indication from the radio network cell that CE is restricted). For instance, a radio network cell may indicate to the device whether restriction checks should be performed based on time and/or based on position. The radio frequency device may be arranged to determine when and/or how to perform a restriction check in response to said received information.

The radio frequency device may be arranged to perform the restriction check repeatedly, e.g. continuously through operation in the third mode. The radio frequency device may be arranged to perform the restriction check at regular intervals. In other words, the radio frequency device may be arranged to perform a periodic restriction check on CE restrictions. A frequency with which the restriction check is repeated may be pre-set (e.g. hard-coded into the firmware of the device), or determined during operation (e.g. by the radio network cell or by the device).

In a set of embodiments, the radio frequency device is arranged to receive information indicating a frequency at which to perform a restriction check (e.g. from a radio network cell). For instance, the radio frequency device may be arranged to receive information indicating a frequency at which to perform a restriction check at the same time as receiving an indication from the radio network cell that CE is restricted. The radio frequency device may be arranged to store said information to a memory (e.g. a non-volatile memory). In relevant embodiments, this may be the same memory as that used to store information indicating a CE restriction (e.g. a CE restriction flag), or it may be a different memory. For instance, information indicating a CE restriction may be stored to a dedicated flash memory and information indicating a frequency at which to perform a restriction check may be stored to a separate non-volatile memory.

The radio frequency device may be arranged to perform other regular or irregular checks. The restriction may be combined with one or more other checks. In a set of embodiments, for instance, the restriction check is comprised by a periodic tracking area update (TAU) procedure.

In a set of embodiments, additionally or alternatively, the radio frequency device is arranged to determine position information and, when operating in the third mode, to perform a restriction check based on said position information (i.e. triggered by position information). For instance, the radio frequency device may be arranged, when operating in the third mode, to perform a restriction check when said position information indicates the radio frequency device has moved from a first area into a second area. The position information may comprise geographic location information (e.g. GPS coordinates), but in a set of embodiments the position information comprises radio network area information, i.e. an indication of which part of a radio network (e.g. cell, tracking area) the radio frequency device is in.

The radio frequency device may be arranged to perform one or more restriction checks based on position information in response to information (e.g. from a radio network cell) indicating when and/or how to perform a restriction check. For instance a radio network may indicate to the radio frequency device whether the CE restriction is area specific, network-wide, or something else, and the radio frequency device and/or the network may then decide if and when a restriction check based on position information is appropriate. For instance, if a radio network indicates to the radio frequency device that the CE restriction is network-wide, position-based restriction checks may be less useful (because a change in restriction is unlikely to coincide with the change of position).

The first and second areas may be network tracking areas defined by the coverage of one or more radio network cells (i.e. having respective tracking area identities (TAIs)). For instance, the radio frequency device may be arranged to perform a restriction check as part of a TAU procedure when moving from a first network tracking area to a second network tracking area (e.g. from one cell to another). In other words, the radio frequency device may be arranged to perform a restriction in response to detecting a change in tracking area identity. Performing a restriction check as part of a TAU procedure when moving from a first network tracking area to a second network tracking area has the additional benefit of providing the network with updated information on the position of the radio frequency device. The network may keep a record of areas where the radio frequency device has received CE restriction information (e.g. the radio network may maintain a list of TAIs the radio frequency device has received restriction information for).

In some embodiments, the radio frequency device is arranged to record CE restriction information associated with one or more areas (i.e. to make a note of whether CE operation is restricted in a particular area). The radio frequency device may be arranged, when operating in the third mode, to perform the restriction check when said position information indicates the radio frequency device has moved from a first area into a second area and the radio frequency device does not have recorded restriction information for the second area (e.g. because the device has not operated in the second area before). Additionally or alternatively, the radio frequency device may be arranged, when operating in the third mode, to perform the restriction check when said position information indicates that the radio frequency device has moved from a first area into a second area and the radio frequency device only has recorded restriction information for the second area that that is older than a threshold age (i.e. out-of-date restriction information). Only performing position-triggered restriction checks when entering a new area (or when restriction information for a given area is older than a threshold) may avoid the device continually carrying out restriction checks when located at a border between two tracking areas.

In a set of embodiments, additionally or alternatively, the radio frequency device is arranged, when operating in the third mode, to monitor for a paging signal from a radio network cell indicating that CE operation is not restricted, and to transition from operating in the third mode to operating in the second mode if the paging signal indicates that CE operation is not restricted. In other words, the radio frequency device may be arranged to receive a paging signal which indicates that a CE restriction can be overridden. The paging signal that indicates CE restriction information may be one of several paging signals the radio frequency device is arranged to receive. The paging signal that indicates CE restriction information comprise a paging signal dedicated for CE restriction information or it may also carry other information. The paging signal may, for instance, comprise an existing paging signal specified by the LTE-M protocol that is repurposed to provide CE restriction information.

The RF device being arranged to transition from the third mode to the second mode in response to a paging signal allows the radio network cell to initiate CE operation of the device (i.e. by sending the paging signal). The paging signal may be used to inform the RF device quickly of changes in CE restrictions, without having to wait for a periodic restriction check or for the RF device to enter a new area.

The radio network may be arranged to transmit said paging signal in one, several or all possible radio network cells, e.g. depending on the accuracy with which the radio network knows the radio frequency device's location. In some embodiments, the radio network may be arranged to determine the current position of the radio frequency device and transmit the paging signal in one or more radio network cells corresponding to said current position (i.e. the paging signal may be targeted to a specific area or areas containing the radio frequency device). For instance, in embodiments where the RF device is arranged to perform a restriction check when moving from a first area into a second area, this may inform the radio network that the RF device has entered the second area and allow for targeting paging. The radio network may be arranged to transmit said paging signal in one or more radio network cells corresponding to the last known position of the RF device.

In some embodiments, the radio network is arranged to keep a record of areas where the radio frequency device has received CE restriction information and to transmit said paging signal in one or more cells selected based on said record. For instance, the radio network may be arranged to transmit said paging signal in cells corresponding to areas in which the device has received any CE restriction information, or an indication that coverage enhancement is restricted. This may facilitate sending the paging signal to the RF device when the position of the device is uncertain or unknown. For instance, if the device is arranged to perform a TAU only when entering a new tracking area, the radio network may not receive any specific position updates from TAUs whilst the device is moving amongst known tracking areas, but may be reasonably confident that the RF is nevertheless located one of such areas. If the RF device is not reachable with targeted paging signals, the radio network may be arranged to transmit the paging signal in all possible tracking areas.

In some embodiments (e.g. in which the radio frequency device only performs a position-triggered restriction check when entering a new area), the radio network may be arranged to transmit said paging signal in all areas where the radio frequency device has received CE restriction information, because the device may have entered one of said areas without performing a TAU procedure.

In a set of embodiments, the RF device is arranged, when operating in the third mode, to determine if exceptional data needs to be transmitted and to transition from operating in the third mode to operating in the second mode if exceptional data needs to be transmitted. For instance, the RF device may determine that data related to an emergency needs to be transmitted (e.g. a call to emergency services). In some embodiments, the RF device may be arranged to transition to the second mode if exceptional data needs to be transmitted only to transmit said exceptional data and to transitioning back to the third mode after said exceptional data has been transmitted. In other words, the device may be arranged to override the CE restriction only briefly in exceptional circumstances.

The invention extends to a method of operating the radio frequency device disclosed herein, the method comprising the radio frequency device transitioning from operating in the third mode to operating in the second mode without operating in the first mode.

The RF device may be arranged to transition from operating in the third mode to operating in the second mode without operating in the first mode in a variety of situations. For instance, the RF device may transfer from an enhanced coverage zone of a first cell which restricts CE operation to an enhanced coverage zone of a second cell which permits CE operation. This transfer may be the result of the RF device and/or base stations defining the first and/or second cells physically moving. Additionally or alternatively, the transfer may be the result of a change in RF conditions in or near the first and/or second cells. For instance, the movement of surrounding objects or weather conditions can affect RF signal propagation and thus affect which cell the RF device falls under.

Additionally or alternatively, the RF device may be arranged to transition from operating in the third mode to operating in the second mode without operating in the first mode as a result of a change in CE restrictions in a single cell. For instance, a cell may be arranged to restrict CE use when it is busy (e.g. serving a large number of devices) and to permit CE use when it is quieter.

Additionally or alternatively, the RF device may be arranged to transition from operating in the third mode to operating in the second mode without operating in the first mode as a result of a change in CE restrictions on the RF device. For instance, a network may remove a CE restriction placed on an individual RF device (or a set of related RF devices) in response to a new network usage policy, and/or in response a user changing a subscription level.

The RF device may of course also be arranged to transition from operating in the third mode to operating in the second mode via a period of operation in the first mode. For instance, the RF device may move from a CE zone of a first cell which restricts CE operation (where the RF device operates in the third mode) to a standard coverage zone of a second cell which permits CE operation (where the RF device operates in the first mode) and then to a CE zone of the second cell (where the RF device operates in the second mode). In such embodiments, the RF device may receive updated CE restriction information whilst operating in the first mode.

In a set of embodiments, the radio network comprises a Long Term Evolution (LTE) network such as an LTE Machine Type Communication (LTE-M) network. The radio network may comprise one or more base stations defining one or more radio network cells. For instance, the radio network may comprise one or more LTE eNodeBs. In a set of embodiments, the RF device comprises LTE User Equipment (UE).

Features of any aspect or embodiment described herein may, wherever appropriate, be applied to any other aspect or embodiment described herein. Where reference is made to different embodiments, it should be understood that these are not necessarily distinct but may overlap.

### BRIEF DESCRIPTION OF THE DRAWINGS

One or more non-limiting examples will now be described, by way of example only, and with reference to the accompanying figures in which:

FIGS. 1 and 2 are schematic diagrams illustrating a radio network according to an example of the present invention;

FIG. 3 is a flow diagram illustrating an example operation of the radio network;

FIG. 4 is a flow diagram illustrating another example operation of the radio network;

FIG. 5 is a flow diagram illustrating another example operation of the radio network; and

FIG. 6 is a flow diagram illustrating another example operation of the radio network.

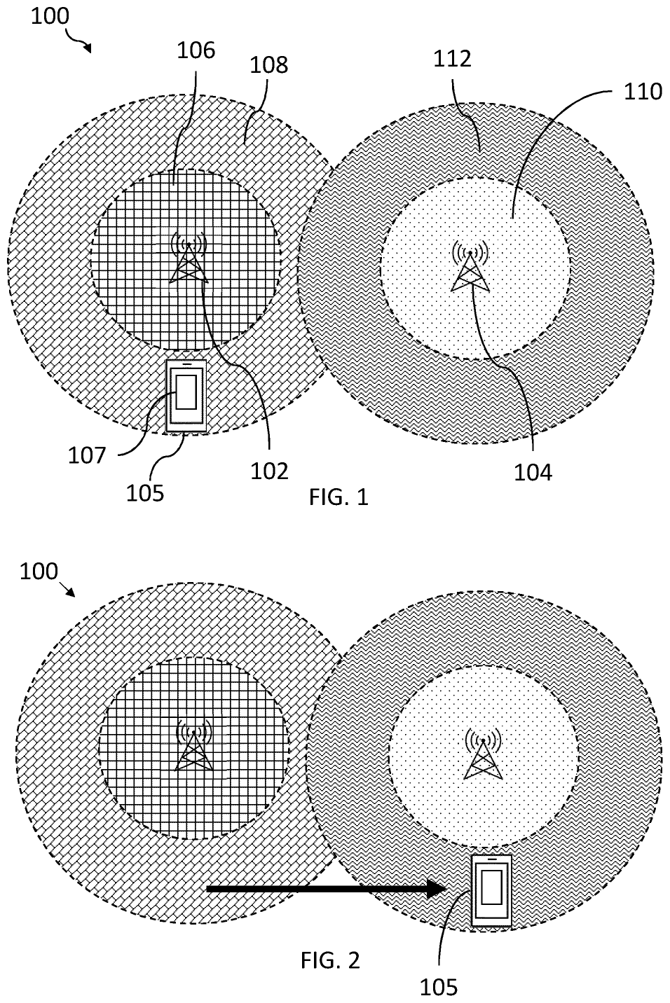

FIGS. 1 and 2 show an LTE-M radio network 100. The radio network comprises a first eNodeB 102, a second eNodeB 104 and user equipment (UE) 105. In this example the UE 105 is illustrated as a mobile telephone, although it will be recognised that many other types of UE may be used. The UE 105 comprises a non-volatile memory (NVM) 107, e.g. a flash memory.

The first eNodeB 102 defines a first cell of the radio network 100. The first eNodeB 102 covers a first standard coverage zone 106 and a larger first coverage enhanced (CE) zone 108. Similarly, the second eNodeB 104 covers a second standard coverage zone 110 and a larger second CE zone 112. UEs (such as UE 105) in the standard coverage zones 106, 110 can communicate with the respective eNodeB 102, 104 using a standard LTE-M frame structure.

Devices in the CE zones 108, 112 can communicate with the respective eNodeB 102, 104 using a CE communication protocol, subject to restrictions discussed below. In the CE communication protocol, one or more portions of the LTE-M frame are repeated to facilitate additional error correction and to enable communication over a greater distance than the standard communication protocol.

In these drawings, the standard and CE zones 106, 108, 110, 112 are shown as simple circles. However, it will be appreciated that these zones may in reality be highly irregular, depending for instance on environmental factors. In general, the standard coverage zones 106, 110 may correspond to areas in which the signal strength from the eNodeBs 102, 104 is sufficiently high to support the standard communication protocol. The CE zones 108, 112 may correspond to areas in which the signal strength from the eNodeBs 102, 104 is too low to support the standard communication protocol but which is sufficiently high to support the CE communication protocol.

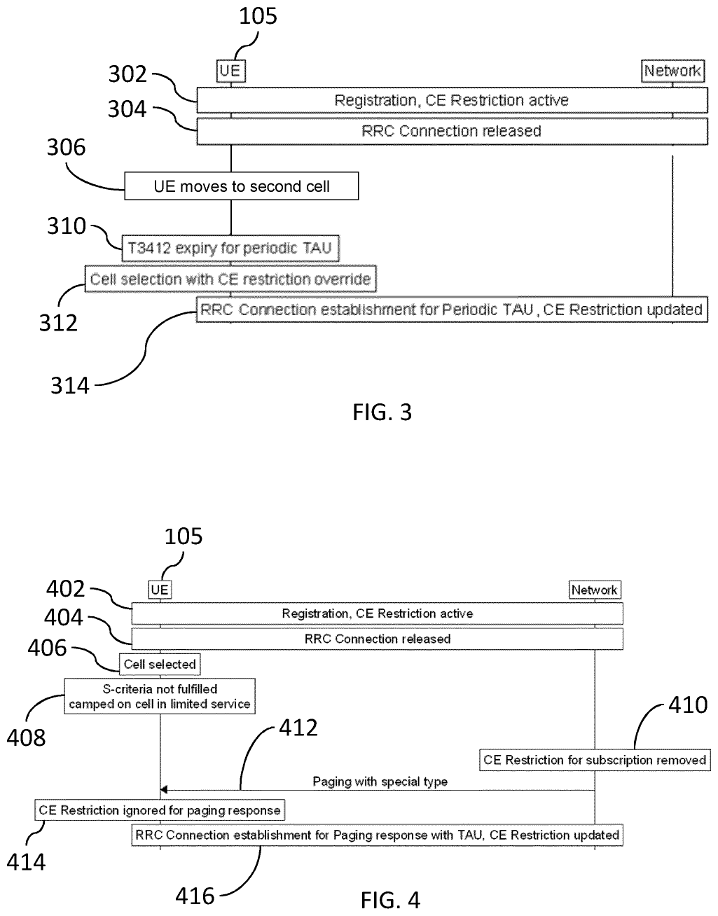

The operation of the radio network 100 will now be described with additional reference to FIG. 3. In a first step 302, the UE 105 is located in the first CE zone 108 and forms a Radio Resource Control (RRC) connection with the first eNodeB 102 to perform a registration process. As part of the registration process, the first eNodeB 102 signals to the UE 105 that CE communication is restricted in the first CE zone 108.

The UE 105 notes the CE restriction and stores it to the NVM 107 (e.g. by setting a CE-restricted flag). At step 304, the Radio Resource Control connection is released and the UE 105 begins operating in a CE-restricted mode in which it does not carry out data communication with the eNodeB 102 due to the restriction.

In step 306, shown in FIG. 2, the UE moves to the second CE zone 112. There is no CE restriction in force for the second CE zone 112. However, the UE 105 is in the CE-restricted mode due to the CE restriction stored it to the NVM 107 and thus does not immediately establish an RRC connection with the second eNodeB 104, e.g. for TAU due to tracking area change.

However, whilst in the CE-restricted mode, the UE 105 performs periodic a TAU procedure that include a CE restriction check. In step 310, a T3412 timer expires and triggers a TAU procedure. The period of the T3412 timer is set by the radio network and stored to the NVM 107.

In step 312, as part of the TAU check, the UE 105 temporarily overrides the CE restriction and performs cell selection. Because the UE 105 is in the second CE zone 112, in step 314 the UE 105 selects the second eNodeB 104 and establishes an RRC connection. The UE 105 receives a signal from the second eNodeB 104 indicating that there is no CE restriction in place. The UE 105 stores this to the NVM 107 (e.g. resetting the CE restriction flag) and transitions into a CE-active mode in which the UE 105 communicates with the second eNodeB 104 using the CE communication protocol.

Thus, the UE 105 is able to make use of CE communication that is permitted in the second cell without needing to first enter the second standard coverage zone 110.

Another example of the operation of the radio network 100 shown in FIG. 1 will now be described with additional reference to FIG. 4.

In step 402, the UE 105 is located in the first CE zone 108 and forms a Radio Resource Control (RRC) connection with the first eNodeB 102 to perform a registration process. As part of the registration process, the first eNodeB 102 signals to the UE 105 that CE communication is restricted. In this case, CE communication is restricted for the specific UE 105, e.g. due to the UE 105 having an insufficient privilege level for CE operation.

The UE 105 notes the CE restriction and stores it to the NVM 107 (e.g. by setting a CE-restricted flag). At step 404, the Radio Resource Control connection is released and the UE 105 begins operating in a CE-restricted mode.

In step 406, the UE 105 performs cell selection. However, because the UE 105 is restricted from using the CE communication protocol, the first eNodeB 102 does not fulfil the cell selection criteria (S-criteria) and in step 408 the UE 105 simply camps on the cell defined by the eNodeB 102 in a limited service state, i.e. in a CE-restricted mode.

In step 410, the network removes the CE restriction on the UE 105 (e.g. due to the owner of the UE 105 purchasing an additional subscription feature). In response, in step 412, the first eNodeB 102 sends a paging signal to the UE 105.

In step 414, the UE 105 detects the paging signal and overrides the CE restriction. In step 416, the UE 105 establishes an RRC connection with the first eNodeB 102. The UE 105 receives a signal from the first eNodeB 102 indicating that there is no CE restriction in place. The UE 105 stores this to the NVM 107 (e.g. resetting the CE restriction flag) and transitions into a CE-active mode in which the UE 105 communicates with the first eNodeB 102 using the CE communication protocol.

Thus, the UE 105 is able to promptly make use of CE communication as soon as the restriction is removed, without needing to wait until entering a standard coverage zone.

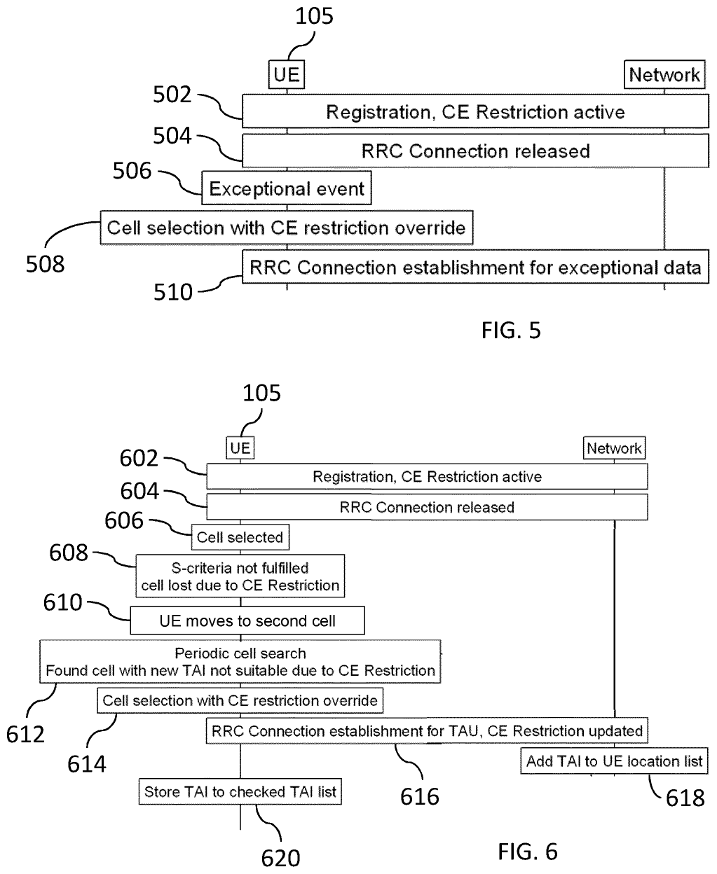

Another example of the operation of the radio network 100 shown in FIG. 1 will now be described with additional reference to FIG. 5.

In step 502, the UE 105 is located in the first CE zone 108 and forms a Radio Resource Control (RRC) connection with the first eNodeB 102 to perform a registration process. As part of the registration process, the first eNodeB 102 signals to the UE 105 that CE communication is restricted. In this case, CE communication is restricted for the specific UE 105, e.g. due to the UE 105 having an insufficient privilege level for CE operation.

The UE 105 notes the CE restriction and stores it to the NVM 107 (e.g. by setting a CE-restricted flag). At step 504, the Radio Resource Control connection is released and the UE 105 begins operating in a CE-restricted mode.

At step 506, an exceptional event occurs that creates an exceptional need for the UE 105 to transmit data to the network. For instance, the UE 105 may attempt to make an emergency call.

In step 508, in response to the exceptional event, the UE 105 performs cell selection, overriding the CE restriction and selecting the cell defined by the first eNodeB 102. In step 510, the UE 105 establishes an RRC connection with the first eNodeB 102. The first eNodeB 102 recognises the exceptional need to transmit data and permits CE communication. The UE 105 temporarily transitions into a CE-active mode in which the UE 105 communicates with the first eNodeB 102 using the CE communication protocol. When the exceptional data has been transmitted, the RRC connection is released and the UE 105 transitions back into the CE-restricted mode.

Thus, the UE 105 is able to react to a need to send exceptional data even when a CE restriction is in place.

Another example of the operation of the radio network 100 shown in FIG. 1 will now be described with additional reference to FIG. 6.

In step 602, the UE 105 is located in the first CE zone 108 and forms a Radio Resource Control (RRC) connection with the first eNodeB 102 to perform a registration process. In this example the first eNodeB 102 is in a first network tracking area (i.e. has a first Tracking Area Identity (TAI)) and the second eNodeB 104 is in a second network tracking area (i.e. has a second Tracking Area Identity (TAI)).

As part of the registration process, the first eNodeB 102 signals to the UE 105 that CE communication is restricted in the network 100. The UE 105 notes the CE restriction and stores it to the NVM 107 (e.g. by setting a CE-restricted flag). At step 604, the Radio Resource Control connection is released and the UE 105 begins operating in a CE-restricted mode.

In step 606, the UE 105 performs cell selection. However, because the UE 105 is restricted from using the CE communication protocol, the first eNodeB 102 does not fulfil the cell selection criteria (S-criteria) and in step 608 the UE 105 loses the connection with the cell. The UE 105 notes that the first tracking area has a CE restriction and stores the first TAI to a checked TAI list.

In step 610, shown in FIG. 2, the UE moves to the second CE zone 112, i.e. into the second tracking area. In the time since the initial registration process in the first tracking area, the network 100 has removed the CE restriction. As such, there is no CE restriction in force when the UE moves into the second CE zone 112. In step 612, the UE 105 performs a periodic cell search and identifies that it is in the second tracking area (i.e. by detecting the second TAI). The UE 105 performs a TAU procedure in which the UE 105 temporarily overrides the previously set CE restriction and performs cell selection in step 614. The second TAI is not in the checked TAI list recorded by the UE 105 and so in step 616 the UE 105 establishes an RRC connection. The UE 105 receives a signal from the second eNodeB 104 indicating that there is no CE restriction in place. The UE 105 stores this to the NVM 107 (e.g. resetting the CE restriction flag) and transitions into a CE-active mode in which the UE 105 communicates with the second eNodeB 104 using the CE communication protocol.

In step 618, the radio network notes that the UE 105 has visited the second network tracking area, by adding the second TAI to a UE location list.

If the UE 105 subsequently returns to the first tracking area, it performs another TAU procedure and restriction check because the network restriction status has changed since it last visited the first tracking area.

Alternatively, if the network CE restriction was not removed before the UE 105 moved into the second tracking area, the TAU procedure on entry to the second area would indicate that the CE restriction is still in place. When subsequently returning to the first area, the UE 105 may note that the first TAI is already in the checked TAI list and may assume that the previously-identified CE restriction remains in place without performing a new restriction check.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A radio frequency device arranged to communicate with a radio network cell of a radio network, wherein the radio frequency device is arranged:
to operate in a first mode in which the radio frequency device communicates with a radio network cell using a standard communication protocol;
to operate in a second mode in which the radio frequency device communicates with a radio network cell using a coverage enhancement communication protocol;
to operate in a third mode in which the radio frequency device is restricted from communicating with a radio network cell using the coverage enhancement communication protocol; and
to transition from operating in the third mode to operating in the second mode without operating in the first mode.

2. The radio frequency device of claim 1, arranged to operate in the third mode following a registration procedure with a radio network cell, said registration procedure including an indication from the radio network cell that coverage enhancement operation is restricted.

3. (canceled)

4. The radio frequency device of claim 1, wherein, when operating in the third mode the radio frequency device is prevented from selecting radio network cells that can only be accessed using coverage enhancement operation.

5. The radio frequency device of claim 1, wherein the standard communication protocol comprises communicating with a radio network cell using a first frame structure and the coverage enhancement communication protocol comprises communicating with a radio network cell using a second frame structure, wherein the second frame structure comprises the first frame structure with one or more repeated portions, wherein the second frame structure comprises the first frame structure with one or more repeated portions.

6. (canceled)

7. The radio frequency device of claim 5, wherein the first frame structure comprises an LTE-M uplink or downlink frame structure.

8. The radio frequency device of claim 5, wherein the first frame structure is associated with a first data rate and/or a first latency, and the second frame structure is associated with a second, lower data rate and/or a second, higher latency.

9. The radio frequency device of claim 1, arranged, when operating in the third mode, to perform a restriction check on coverage enhancement restrictions.

10. The radio frequency device of claim 9, arranged, when operating in the third mode, to perform a periodic restriction check on coverage enhancement restrictions.

11. The radio frequency device of claim 10, arranged to receive information indicating a frequency at which to perform the periodic restriction check from a radio network cell.

12. (canceled)

13. The radio frequency device of claim 9, arranged to determine position information and, when operating in the third mode, to perform a restriction check based on said position information.

14. The radio frequency device of claim 13, arranged, when operating in the third mode, to perform a restriction check when said position information indicates the radio frequency device has moved from a first area into a second area.

15. The radio frequency device of claim 14, arranged to perform a restriction check as part of a tracking area update procedure when moving from a first network tracking area to a second network tracking area.

16. The radio frequency device of claim 14, arranged to record overage enhancement restriction information associated with one or more areas and, when operating in the third mode, to perform a restriction check when the radio frequency device does not have recorded restriction information for the second area.

17. The radio frequency device of claim 9, arranged to receive information indicating when and/or how to perform the restriction check.

18. The radio frequency device of claim 1, arranged, when operating in the third mode, to monitor for a paging signal from a radio network cell indicating that coverage enhancement operation is not restricted, and to transition from operating in the third mode to operating in the second mode if the paging signal indicates that coverage enhancement operation is not restricted.

19. The radio frequency device of claim 1, arranged, when operating in the third mode, to determine if exceptional data needs to be transmitted and to transition from operating in the third mode to operating in the second mode if exceptional data needs to be transmitted.

20. The radio frequency device of claim 1, wherein the radio frequency device comprises LTE User Equipment.

21. A method of operating a radio frequency device comprising:
operating the radio frequency device in a first mode in which the radio frequency device communicates with a radio network cell using a standard communication protocol;
operating the radio frequency device in a second mode in which the radio frequency device communicates with the radio network cell using a coverage enhancement communication protocol;
operating the radio frequency device in a third mode in which the radio frequency device is restricted from communicating with the radio network cell using the coverage enhancement communication protocol; and
transitioning from operating in the third mode to operating in the second mode without operating in the first mode.

22. A radio network comprising at least one radio network cell and a radio frequency device arranged to communicate with the radio network cell, wherein the radio frequency device is arranged:
to operate in a first mode in which the radio frequency device communicates with the radio network cell using a standard communication protocol;
to operate in a second mode in which the radio frequency device communicates with the radio network cell using a coverage enhancement communication protocol;
to operate in a third mode in which the radio frequency device is restricted from communicating with the radio network cell using the coverage enhancement communication protocol; and
to transition from operating in the third mode to operating in the second mode without operating in the first mode.

23. The radio network of claim 22, comprising an LTE Machine Type Communication network.
